(19) United States
(12) Patent Application Publication
(10) Pub. No.: US 2020/0238797 A1
(43) Pub. Date: Jul. 30, 2020

(54) IMPROVED ANTI-REFLECTIVE FUNCTIONAL COATING FOR GLAZINGS

(71) Applicant: CENTRAL GLASS COMPANY, LIMITED, Yamaguchi (JP)

(72) Inventors: Michael Bard, Primm Springs, TN (US); Hiromi HASE, Saitama (JP)

(73) Assignee: CENTRAL GLASS COMPANY, LIMITED, Yamaguchi (JP)

(21) Appl. No.: 16/754,311

(22) PCT Filed: Oct. 9, 2018
(86) PCT No.: PCT/US2018/054964

§ 371 Date: Apr. 7, 2020

Related U.S. Application Data
(60) Provisional application No. 62/570,481, filed on Oct. 10, 2017.
(60) Provisional application No. 62/570,564, filed on Oct. 10, 2017.
(60) Provisional application No. 62/685,391, filed on Jun. 15, 2018.

(51) Int. Cl. B60J 3/00; C03C 17/34

(52) U.S. Cl. CPC B60J 3/007; C03C 17/3411; C03C 2218/33; C03C 2217/452; C03C 2217/425; C03C 2217/734

(57) ABSTRACT

The present disclosure relates to an improved anti-reflective architectural or automotive glass. The glass may include a porous, nano-structured anti-reflective coating on at least one side of a glass product, including tempered or laminated glass. The porous, nano-structured anti-reflective coating may include pores increasing in size from a base layer at a glass substrate towards a porous surface. The porous, nano-structured anti-reflective coating, in some embodiments, may be on both surfaces of a glass product. Alternative embodiments include a painted surface on a second side of the glass product to provide an improved aesthetic glass design.

### CROSS REFERENCE TO RELATED APPLICATIONS

This application claims priority to U.S. Provisional Patent Application No. 62/570,481 filed on Oct. 10, 2017, entitled “Improved Anti-Reflective Functional Coating for Automotive Glazing,” U.S. Provisional Patent Application No. 62/570,564 filed on Oct. 10, 2017, entitled “Enhanced Aesthetic Glass Appliques for Exterior and Interior Applications,” and U.S. Provisional Patent Application No. 62/685,391 filed on Jun. 15, 2018, entitled “Improved Anti-Reflective Functional Coating for Glazing,” the contents of which are incorporated by reference herein in their entireties.

### TECHNICAL FIELDS

The present disclosure generally relates to coatings for transparent articles such as a glass substrate, and more specifically relates to coatings having an improved anti-reflective functionality, based on a nano-structured thin film.

### BACKGROUND

Currently existing architectural and automotive glass products inherently include a certain level of reflectivity. Typically, a glass surface may reflect about 4% of visible light. This may lead to undesirable glare that interferes with vision around the glass substrate, including a driver in an automobile. The intensity of a reflection may be elevated based on the environment. For instance, a light-colored surface, such as a dashboard, may provide a bright reflection off a windshield or a front door window. Architectural and automotive glass surfaces are often exposed to various elements which may require a durable surface that is not damaged by such elements. There is a need in the art for a solution to provide anti-reflective glass surfaces that are durable enough to be used in architectural and automotive constructions.

The following disclosure is based, in part, on certain coating technology published by Oak Ridge National Laboratory (ORNL) in the non-patent literature, Aytug, T. et al., Journal of Materials Chemistry C, Vol. 3, No. 21, pp. 5440-5449 (2015). This publication discloses a monolithic nano-structured coating comprising an interconnected network of nanoscale pores surrounded by a nanostructured silica framework, created through metastable spinodal phase separation. Among other things, the literature disclosed: “low-refractive index antireflective glass films that embody omni-directional optical properties over a wide range of wavelengths, while also possessing specific wetting capabilities.” The surface microstructures may have a graded reflective index, providing antireflective properties, suppressing surface reflection. The surface chemistry may be adjusted to provide self-cleaning qualities and provide resistance to mechanical wear and abrasion.

### SUMMARY OF THE DISCLOSURE

The present disclosure relates generally to an automotive or architectural glass product comprising a first side and a second side wherein the first side faces an exterior side of the automotive or architectural glass product and the second side faces an interior side of the automotive or architectural glass product; a first anti-reflective coating on the first side of the glass product; and at least one of a second anti-reflective coating or a paint on the second side of the glass product, wherein the first anti-reflective coating is a first nano-structured coating having nano-structures less than or equal to 400 nm, the first anti-reflective coating has nanopores increasing in size through the first anti-reflective coating from the glass product to a first coating surface opposite the glass product, and the glass product has a reflectivity of 1% or less over wavelengths from 380 nm to 700 nm.

In certain embodiments, the glass product is an automotive glass product. In some embodiments, the first side of the glass product faces a vehicular exterior and the second side of the glass product faces a vehicular interior. Further, the second anti-reflective coating may comprise a second nano-structured coating having nano-structures less than or equal to 400 nm wherein the second anti-reflective coating has nanopores increasing in size through the second anti-reflective coating from the glass product to a second coating surface opposite the glass product.

In certain embodiments, the second side of the glass product is coated with a paint, which may be an enamel paint and may cover at least 90% of the second side of the glass product.

Further embodiments include a functional coating that is at least one of water repellent and omni phobic on the first anti-reflective coating. The first anti-reflective coating may have a water droplet contact angle that is at least 150 degrees, wherein the contact angle of the first anti-reflective coating is at least 150 degrees after aluminum oxide is applied thereto at a rate of 5 gm/minute for 8 minutes at 40 km/hr.

In some embodiments, the glass product comprises a first glass substrate laminated with a second glass substrate, wherein the first glass substrate comprises the first side of the glass product and the second glass substrate comprises the second side of the glass product, wherein the first and second glass substrates are substantially parallel and spaced apart from each other with at least one polymer interlayer therebetween. Further, the second anti-reflective coating may comprise a second nano-structured coating having nano-structures less than or equal to 400 nm. In certain embodiments, second side of the glass product is coated in a paint which is enamel paint and may cover at least 90% of the second side of the glass product.

In certain embodiments, the glass product has a reflectivity of 0.6% or less over wavelengths from 380 nm to 700 nm, preferably 0.4% or less.

In further embodiments, the first anti-reflective coating and the second anti-reflective coating provided on the first and second sides of the glass product, respectively, result in an intensity aspect ratio of greater than 117:1.

In certain embodiments, the reflection from the first side of the glass product having the first anti-reflective coating at an angle from −40° to 40° is within 1% of reflection at 0°, wherein the first anti-reflective coating is substantially a single layer.

In some embodiments, the glass product comprises a functional coating that is at least one of water repellent and omni phobic on a second anti-reflective coating. The water repellent functional coating may have a water droplet contact angle greater than 150 degrees. Further, the contact angle of the second anti-reflective coating is at least 150 after aluminum oxide is applied thereto at a rate of 5 gm/minute for 8 minutes at 40 km/hr.

In particular embodiments, the first anti-reflective coating comprises silica-based structures and sodium-borate-based portions. In certain embodiments, a passivation layer is included between the first anti-reflective coating and the glass product.

The glass product may comprise soda-lime-silica glass. In some embodiments, the first anti-reflective coating is silica-based and is physically vapor deposited onto the glass product.

Disclosed herein is a method of making a glazing, comprising providing a first glass substrate having first and second surfaces, providing a coating on at least one surface of the first glass substrate, wherein the coating is phase separable, heating the first glass substrate and coating to heat treat the first glass substrate and the cause phase separation in the coating, wherein heat treating the first glass substrate comprises at least one of bending the first glass substrate or tempering the first glass substrate, and etching the coating, wherein the coating has nano-pores less than or equal to 400 nm, wherein etching the coating comprises partially etching the coating with a first etchant, further etching the coating with a second etchant, and removing the second etchant, wherein the second etchant is weaker than the first etchant.

The coating may be provided on the first and second surfaces of the first glass substrate. In certain embodiments, heat treating the first glass substrate comprises bending the first glass substrate. In further embodiments, heat treating the first glass substrate comprises tempering the first glass substrate, wherein phase separation of the coating occurs while the first glass substrate and coating are heated, and then the first glass substrate and coating are cooled at a rate to temper the first glass substrate.

In further embodiments, a second glass substrate having third and fourth surfaces is provided with at least one polymer interlayer, wherein the first and second glass substrates are substantially parallel and spaced apart from each other with the polymer interlayer therebetween. The coating may further be applied to at least one of the third and fourth surfaces.

In certain embodiments, the first glass substrate comprises soda-lime-silica glass and the phase separation may be by spinodal decomposition.

Further disclosed herein is an automotive or architectural glass product, comprising a first side and a second side and a first anti-reflective coating on the first side of the glass product and a paint on the second side of the glass product, wherein the glass product has a reflectivity of 1% or less over wavelengths from 380 nm to 700 nm. The first anti-reflective coating may be a first nano-structured coating having nano-structures less than or equal to 400 nm. In certain embodiments, the paint is an enamel paint and may cover at least 90% of the second side of the glass product.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a typical construction of a laminated glass utilized in automotive, architectural and other applications;

FIG. 2 is a diagram showing an exponential relationship of intensity aspect ratio and combined reflectivity of S1 and S4 surface on a 70% light transmission windshield;

FIG. 3 is a table showing anti-reflective functional coating reflectivity and resulting windshield reflectivity (S1 and S4 combined) at 70% light transmission;

FIG. 4 illustrates anti-reflective coatings on both S1 and S4 surfaces, according to an exemplary aspect of the present disclosure;

FIG. 5 illustrates anti-reflective coatings on both S1 and S4 surfaces with a water repellent or omni-phobic functional coating, according to an exemplary aspect of the present disclosure; and

FIG. 6 illustrates an anti-reflective coating on S1 and a printed S2 on a trim piece, according to an exemplary aspect of the present disclosure.

### DETAILED DESCRIPTION

Disclosed herein are exemplary aspects of an improved anti-reflective functional coating for glazings such as, but not limited to, architectural glazings and automotive glazings. In the following description, for purposes of explanation, specific details are set forth in order to promote a thorough understanding of one or more aspects of the disclosure. It may be evident in some or all instances, however, that any aspects described below can be practiced without adopting the specific design details described below.

Among other features, the present disclosure provides a coaling with improved anti-reflective (AR) functionality and a glazing construction with improved AR functionality. The nano-structured coating previously disclosed has been described as a monolithic coating with properties that may be further established or developed by key processes and material parameters such as: concentrating and mixing glass types, heating at a duration and at temperatures in which phase separation occurs, and etching depth, based on acid or base type and concentrations thereof, as well as the duration of etching.

As used herein, the term “S1” may refer to the exterior glass substrate surface in an automotive application. The term “S4” may refer to the interior glass substrate surface of a laminated automotive glass product. “S2” may be a glass substrate surface opposite S1 and “S3” may be a glass substrate surface opposite S4. In a laminated glass product, S2 and S3 may be a part of the laminate interior. S2 may be an interior glass substrate surface in automotive constructions using a single glass sheet, including a tempered glass sheet. As used herein “invisible” glass may have a total reflectivity of at least less than 1%.

Various functionality of automotive glazing may require focus on different properties, e.g., anti-reflective over water repellent, anti-fog over UV scattering, etc. Configuring one or more properties using a nano-structured coating may be difficult in a monolithic coating design, as previously disclosed.

For example, the optimal anti-reflective properties of a coating may require a theoretically seamless transition from a surrounding element's refractive index (typically air) to a substrate's refractive index (for example, soda lime glass with approximately 1.5 refractive index). By altering the parameters of the phase separation and the depth of etching, this transition may be affected. For instance, the time and temperature at which phase separation occurs may affect how much phase separation there is within the coating. More phase separation may provide larger areas of sodium borate that may be etched away. The amount of etching that is performed may also affect how much sodium borate may be removed from the coating. A monolayer glazing construction may often lead to steps in refractive index too large to optimize the anti-reflective (“AR”) properties to a desired level. In another example, a coating's phase separation may occur during a heating cycle of a typical glass bending and/or stress setting (i.e., annealing or heat strengthening) process. Process requirements for bending or stress setting may not overlap with requirements for phase separation as the durations need to be matched, leading to a potentially incompatible set of process requirements. A non-monolithic nano-structured anti-reflective coating may be desirable for various reasons discussed herein.

In accordance with aspects of the present disclosure, a manufacturing method is disclosed for preparing a glazing construction of a coating with improved anti-reflective functionality through utilization of multiple layers made up of different percentages of glass former such as SiO₂ and glass modifiers (e.g., B₂O₃ and Na₂O, other alkali metal oxides, alkaline earth metal oxides or metal oxide), such that different levels of phase separation may be achieved throughout the coating stack while being exposed to a set temperature and time for phase separation. In one embodiment, the percentage of SiO₂ may decrease from the first to the last deposited layer while B₂O₃ and Na₂O percentages may increase. These layers may be produced in-line in a suitable coating process, i.e., in physical or chemical vapor deposition process such as a sputter coater (i.e., a machine that applies a thin film coating to glass). The coated substrate may then be heated for a suitable time such that the coating phase separates. Differential etching with a suitable acid or base may then be performed to leave SiO₂ having voids, providing a nano-structured coating. The voids may be in the form of nano-pores, nano-pillars, or nano-columns. Si-rich layers closest to the substrate may have relatively smaller pores and larger pores where more sodium borate was etched away may be located at the top layer of the coating. The etching depth may further control pore sizes and anti-reflective properties. For example, the etching process may be chemical and include various strength etchants. The etchants may be applied in series to prove a gradient index of refraction within the nano-structured coating. The gradual change in pore size may create a gradient index of refraction that may limit the reflective properties of the substrate.

The present disclosure further discloses another manufacturing method of a glazing construction of a coating stack with improved anti-reflective functionality where multiple layers of the coating stack may not be produced in-line in a coater. The coating stack may be partially coated (one or more layers with different glass concentrations), then heated to initiate phase separation and etched. After this first cycle, the process may be repeated with one or more additional layers coated onto the previously phase-separated and etched coating stack, heat-treated again to initiate phase separation in the second coating stack and etched again. This process may be repeated multiple times in order to create a final coating with properties that may surpass a monolayer stack for anti-reflective and/or other properties. Each stack may undergo varied etching, such that nano-pores, nano-columns, or nano-pillars in the coating layer may increase in size from a first layer closest to a glass substrate to a top layer.

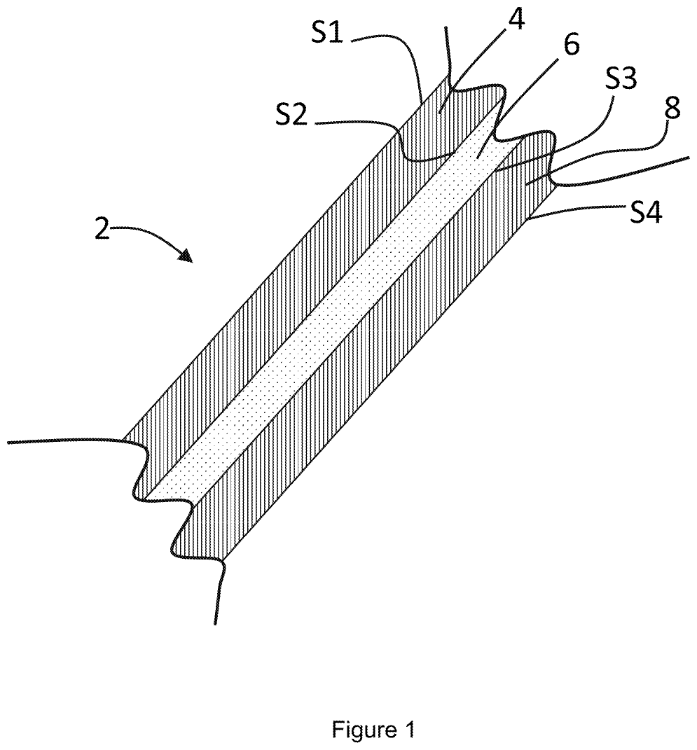

Referring to FIG. 1, a cross-sectional view of a conventional vehicle laminated glazing 2 (i.e., windshield) may include both a first glass substrate 4 and a second glass substrate 8 that may be provided in a substantially parallel, spaced-apart relation to one another. First glass substrate 4 may face a vehicle exterior and include surfaces S1 and S2, and second glass substrate 8 may face a vehicle interior and include surfaces S3 and S4. Glass substrates 4 and 8 may be initially flat and heat treated (e.g., thermally tempered, heat bent, and/or heat strengthened) typically at temperatures of at least 500 deg. C., and more preferably at least about 600 deg. C. During this heat treatment, in certain example windshield applications, the glass substrates 4 and 8 may be bent to the desired curved shape for specific windshield applications. Glass bending preferably occurs at temperatures from 560 deg. C. to 700 deg. C., more preferably from 600 deg. C. to 650 deg. C.

A polymer interlayer 6 may use any suitable polymer laminating material, including polyvinyl butyral (PVB), ethyl vinyl acetate (EVA), and polyethylene terephthalate (PET). The interlayer 6 may be provided to laminate the glass substrates 4, 8 together. During the laminating process, which may include autoclaving, the glass substrate 4, 8 with the polymer interlayer 6 therebetween may be heated to at least one laminating temperature and pressure (for example, 110-160 deg. C. and 10-15 bar) to laminate the glass substrates 4, 8 to one another and form a vehicle windshield 2 or another laminated window product, such as a sunroof or backlite. The first and second parallel spaced apart glass substrates 4 and 8 may sandwich the polymer-inclusive interlayer 6, which may be substantially uniform in thickness, in the assembled windshield 2.

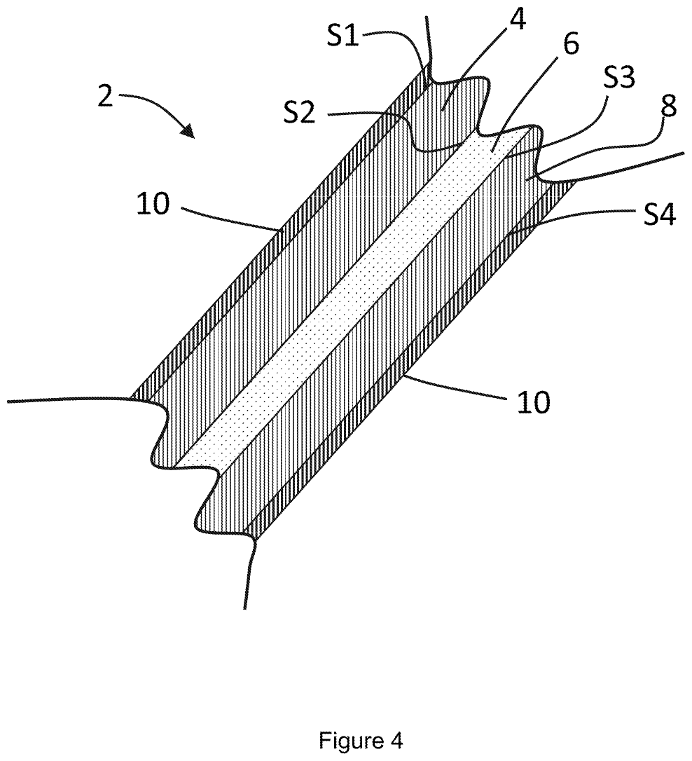

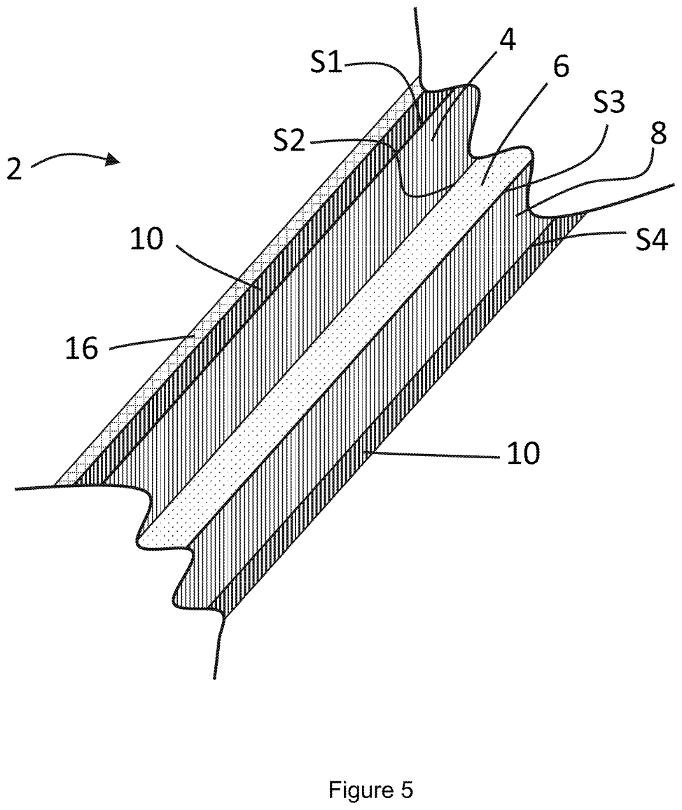

A nano-structured anti-reflective coating 10 may be provided on S1, S2 or S4, depending on the glass product construction, to provide improved anti-reflective properties of a glass substrate or laminate as shown in FIGS. 4 and 5. The nano-structured anti-reflective coating 10 may also be applied to one glass surface S1. Such a construction may provide an improved visibility through the glass product. For example, where the glass product is a windshield 2, the reduced reflectivity may reduce the reflection from a dashboard that may interfere with a driver's visibility.

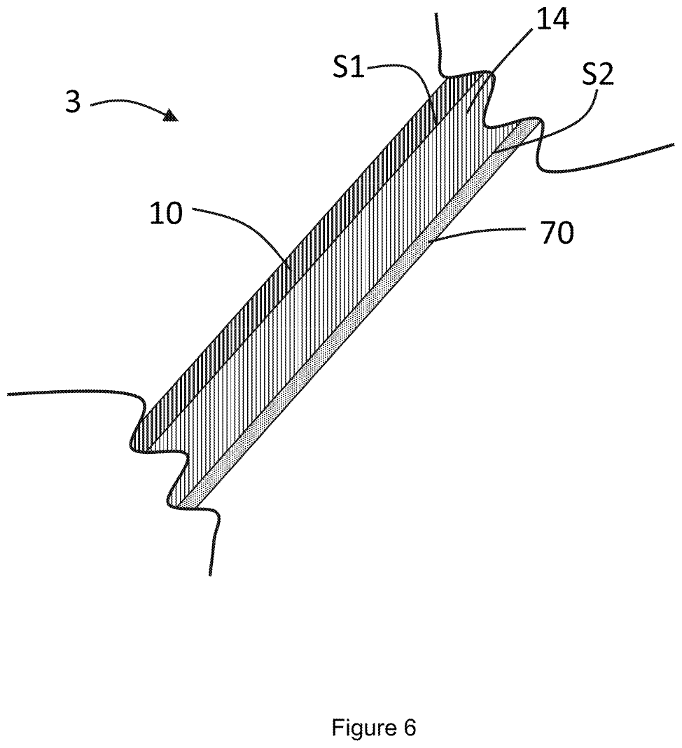

In further preferred embodiments, the nano-structured anti-reflective coating 10 may be provided on S1 and a printed coating 70 may be provided on the opposite glass surface S2 or S4, as shown in FIG. 6. The printed coating 70 may be a paint which may cover at least 90% of the glass surface, preferably at least 95%, and more preferably at least 98%. The paint may preferably include an enamel paint. The paint may be any color or pattern. The painted glass substrate with an anti-reflective coating may provide an aesthetic applique for automotive use. The glass substrate may be strengthened by, for example, tempering, which allows for application in various locations. The glass substrates may be used in a vehicle along pillars adjacent to windows, for example.

In certain preferred embodiments, the nano-structured anti-reflective coating 10 may be applied to at least one of the glass substrates 4, 8 prior to bending. The coating 10 and glass substrate 4, 8 may then be heated to bend the coating 10 and glass substrate 4, 8 and cause phase separation in the coating 10. The coating 10 may then be etched to provide nano-pores, nano-columns, or nano-pillars in the coating 10, which may provide a gradient index of refraction from the air to the glass substrate 4, 8, decreasing any reflection from the glass substrate 4, 8. Preferably, the nano-pores, nano-columns, or nano-pillars may be less than 400 nm in diameter. The coating 10 may be applied to one or both glass substrates 4, 8 in a laminated construction as shown in FIGS. 4 and 5. The coating 10 may further be applied to one or both surfaces of a single glass substrate, such as a tempered glass sheet.

In one aspect, the fabrication of the disclosed nano-structured anti-reflective functional coating 10 may begin with the deposition of a coating that may spinodally (i.e., non-nucleation, continuous phase separation) decompose when properly thermally processed. The glass coating may include a composition that is SiO₂, B₂O₃, and Na₂O. The composition may be adjusted for particular applications by altering the composition of the glass, the duration and temperature of phase separation, and the etching depth. The coating material may include x % SiO₂, y % B₂O₃, and z % R₂O, wherein R may be an alkali metal element such as Li (lithium), Na (sodium) or K (potassium). In certain embodiments, the alkali metal is preferably Na. The sum of x, y, and z may be at least 95, preferably at least 99, and more preferably at least 99.5. Preferably, x may range from 60 to 70, y may range from 20 to 30, and z may range from 5 to 12. More preferably, x may range from 64 to 68, y may range from 24 to 28, and z may range from 6 to 10, wherein an exemplary embodiment may include a composition that is 66% SiO₂, 26% B₂O₃, and 8% Na₂O.

Following film deposition by physical vapor deposition (e.g., magnetron sputtering) or chemical vapor deposition onto transparent substrates 4, 8, which may be soda lime glass, which may be defined by ISO 16293-1:2008, without limitation, the subsequent heat treatment may render the glass coating 10 phase separated into interpenetrating patterns including, e.g., alkali-borate-rich and silica-rich phases, the former being relatively more soluble by a variety of chemicals. Where the deposition is completed by sputter coating, the process may occur in the presence of Ar and O₂ in a ratio of 3:1. Heating the coated substrate 4, 8 simultaneously may cause phase separation in a coating 10 precursor and heat treat the underlying substrate, 4, 8. The underlying substrate 4, 8 may include a glass sheet which may be tempered or bent at temperatures of at least 500 deg. C. and more preferably at least about 600 deg. C for about 10 to 20 minutes. Glass bending may preferably occur at temperatures from 560 deg. C. to 700 deg. C., more preferably from 600 deg. C. to 650 deg. C., and may be held at such temperatures for 10 to 15 minutes. The coated substrate 4, 8 may be cooled after heat treatment. In certain embodiments, it is preferable that the glass substrate 4, 8 may be heated at 700 deg. C. for at least 10 minutes. According to aspects of the present disclosure, such glass bending/tempering process may be configured based on: the specific thickness of the final product, color and/or chemical composition of the glass substrate, where the bending process takes place (out-of-furnace or in-furnace), where the glass cooling process takes place, whether the final product is laminated glass or tempered glass, and required transportation conditions.

Subsequently, a controlled level of differential etching may be employed to selectively dissolve the sodium-borate-rich areas of the coating 10, leaving behind a three-dimensional reticulated network of high-silica content glass phase. Since the spinodal phase separation is a kinetically driven diffusion-controlled process, for a given glass composition, the structure and dimensions of the resultant phases and matrix microstructure may be controlled by the heat treatment temperature and duration, combined with certain etch conditions (i.e., etchant type, concentration, and etch duration). The etching process may preferably form nano-pores less than 400 nm, more preferably the nano-pores are less than 300 nm, and more preferably less than 150 nm. In certain embodiments, the etching may provide at least one nano-pore at least 50 nm in diameter, preferably at least 100 nm in diameter.

The etching process may use any suitable etching chemical. The etching material may leave the silica-rich phase and remove the sodium-borate-rich phase. Suitable etching chemicals include, without limitation, hydrogen chloride, hydrogen fluoride, hydrogen sulfate, and oxide, including buffered variations thereof. The nano-structured anti-reflective coating 10 may have a suitable thickness to provide a gradient index of refraction within the coating with voids that may decrease in size from a surface to a base wherein the base of the coating 10 is at the glass substrate 4, 8, opposite the surface. Preferably, the nano-structured anti-reflective coating 10 thickness may range from 50 nm to 1 μm, more preferably from 100 nm to 400 nm. In an exemplary embodiment, the precursor coating may be applied by magnetron sputter coating to provide a 400 nm thick coating which remains 400 nm after etching. The etching process may not change the thickness of the coating 10, as the silica-rich phase through the coating 10 may remain intact after etching. The etched nano-structured anti-reflective coating 10 may decrease reflectance of a glass surface to by 90%.

Sputter coating the nano-structured coating 10 precursor onto a glass substrate 4, 8 may form a strong bond between the nano-structured coating 10 and the glass substrate 4, 8 when compared to wet coating processes. Further, the structures within the nano-structured coating 10 may be less than 400 nm and remain transparent, even at coating thicknesses above 400 nm. Visible light transmission through the construct may be maintained even with a thick nano-structured coating 10 durable enough for application on an outer glass surface. The thick nano-structured coating 10 may have a sponge-like structure of interconnected nano-structures and nano-pores which may increase the nano-structured coating 10 durability and resistance to impact from hard and sharp objects, such as stone or sand, by absorbing energy from the impact and protecting the underlying substrate 4, 8. The interconnected structure may not easily break away from itself and remain intact over the substrate 4, 8 even through exposure to various physical or chemical elements. Further, the porous nature of the nano-structured coating 10 may remain intact through subsequent heating, including autoclaving typical in glass constructions.

The anti-reflective properties of the nano-structured coating 10 may be affected by the etching process and the gradual change in index of refraction accomplished. The gradual change in index of refraction may prevent a large step change which may lead to a reflection and may be achieved by forming nano-pores within the coating 10 that may be larger at a surface layer in contact with the air. The gradient in nano-pore size within the nano-structured coating 10 may be achieved by various processes, including differential etching with increasingly weak etchants. For example, a strong etchant, hydrochloric acid, may be applied to the phase separated coating and removed prior to completely etching forms pores at a surface layer of the coating 10. Once the strong etchant may be removed, a weaker acid, which may be a buffered hydrochloric acid, may be applied to the coating 10. The weaker etchant may reach below the previously formed pores to begin etching further into the coating. This step may be repeated to form an etched coating 10 that may have pores decreasing in size from a surface towards the underlying substrate 4, 8. The weaker etchants may not completely etch away the sodium-borate-rich phase areas and some sodium-borate phase may remain in the nano-structured coating 10 having a gradient porous structure therein. A passivation layer, which may include SiO₂, TiO₂ or ZrO₂ without limitation may be applied between the underlying substrate 4, 8 and the nano-structured coating 10 to protect the substrate 4, 8 from residual sodium-borate-rich phases. The passivation layer may be 5-300 nm thick.

The application of the disclosed nano-structured anti-reflective functional coating 10 may offer possibilities for new products in automotive applications. A key to these applications may include a very low remaining reflectivity of the coating 10 and applicability on an exterior surface.

Light color interior trims (white, light grey, light blue, beige, etc.) may be disadvantageous in automotive applications, as their reflection in the windshield 2 and front door glass may create glare, causing unsafe driving conditions or at least discomfort for a driver or passenger.

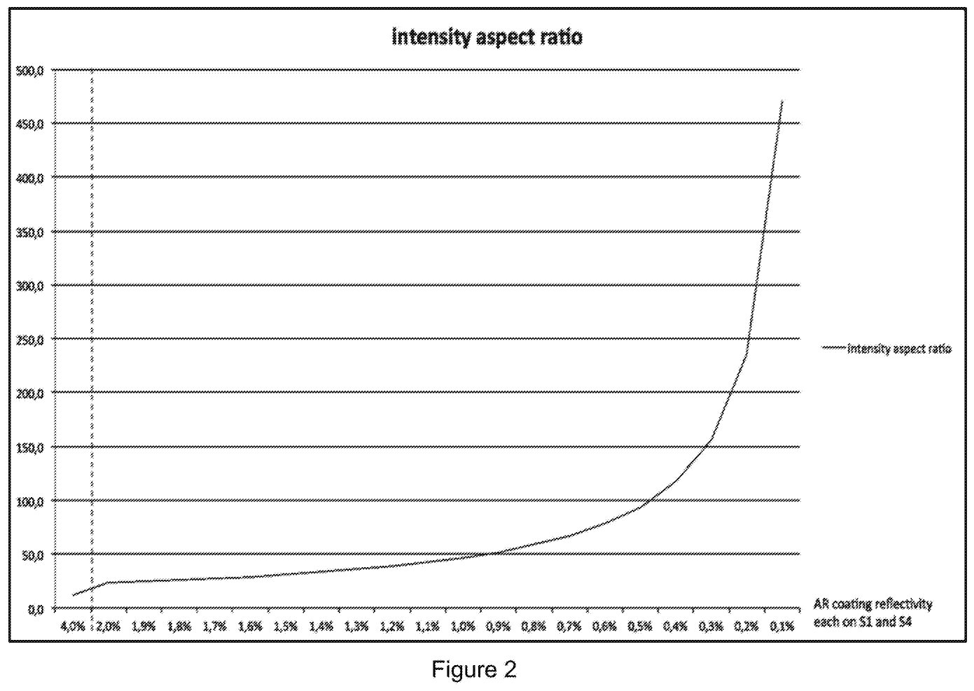

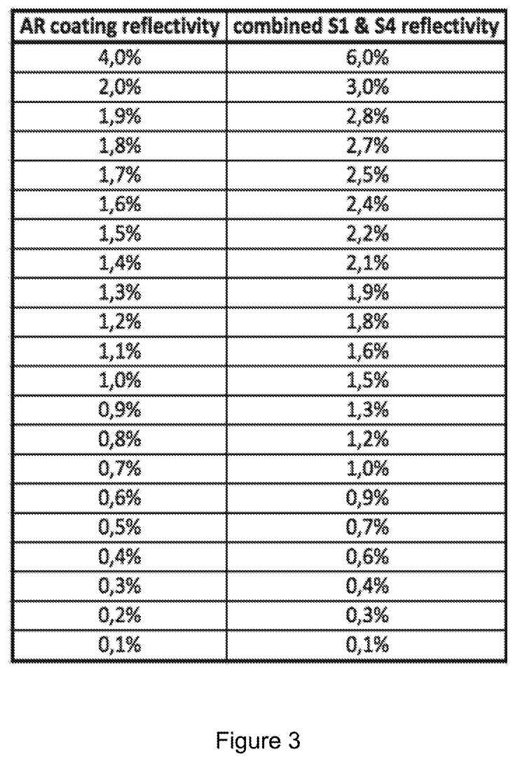

The intensity aspect ratio between light transmission and reflectivity, as shown in FIGS. 2 and 3, may be used to show the problem associated with conventional windshields 2. FIG. 2 illustrates an intensity aspect ratio of transmitted light to reflected light when a nano-structured anti-reflective coating 10 may be applied to S1 and S4 in a windshield 2. FIG. 3 shows the total reflectivity of a laminated glass construct having a nano-structured anti-reflective coating 10 on both S1 and S4 based on various levels of reflectivity. A windshield 2 may have a visible light transmission of at least 70%, based on regulatory requirements, and there may be 4% reflection each from the windshield 2 surfaces S1 and S4, which may provide an aspect ratio of transmitted versus reflected light of 11.7:1. This ratio may be decreased where the light conditions may cause a bright illumination of the interior trim (i.e., dashboard) while a driver is looking at an object with poor illumination (i.e., garage door in shadow), as there may be an increase in reflectivity off the glass surface.

An ideal nano-structured anti-reflective coating on S1 providing 0% reflectivity and no coating on S4 (4% reflectivity) may lead to a combined reflectivity of 2%, or an intensity aspect ratio of 35.7:1, roughly 3 times higher intensity of transmitted light in comparison to reflected light, which may not be considered a solution under unfavorable lighting conditions.

In order to overcome the aforementioned problems, as shown in FIGS. 4 and 5, the present disclosure provides improved nano-structured anti-reflective functional coatings 10 on both S1 and S4 surfaces. S1 coatings that must meet environmental requirements for mechanical and chemical durability, may not be available in conventional systems. According to aspects of the present disclosure, the improved nano-structured anti-reflective coating 10 applied to both S1 and S4 surfaces may meet such requirements. The nano-structured anti-reflective coating 10, having undergone differential etching, may have a porous structure wherein interconnected pores may increase in size towards an underlying substrate 4, 8 and reduce reflectivity by up to 90% over the underlying substrate 4, 8. Soda-lime-silica glass may have reflectivity of about 4% and the nano-structured anti-reflective coating 10 may provide 0.4% reflectivity on each coated surface. In a glass construct having the coated surface on both S1 and S4, the total reflectivity may be 0.6% or less over wavelengths from 380 nm to 700 nm. The reflectance may be determined by ISO 9050:2003. Particularly, a UV-Vis-NIR spectrophotometer with a tungsten lamp may be used for determining reflectivity. The reflection may be reduced for both direct and incident light. For instance, the antireflective coating may provide reflection at an angle from −40° to 40° within 1% of reflection at 0°.

Specifically, an effective anti-reflective coated windshield 2 compatible with bright colored interior trims may have a nano-structured anti-reflective coating 10 on S1 and S4 and intensity aspect ratios greater than 117:1 (10 times less glare than windshield 2 without AR coatings 10). The nano-structured anti-reflective coating 10 having 0.4% reflectivity or less over wavelengths from 380 nm to 700 nm may provide such an intensity aspect ratio.

Further, for situations where communication from inside a vehicle to the outside is required, reflections on surface S1, in combination with low lighting conditions in the vehicle and a 70% light transmission windshield 2. may lead to difficulty seeing and understanding the message sent from inside the vehicle. For example, communications between a driver and a pedestrian, bicyclist, police officer, etc. may be desired in certain circumstances. Such communication may be particularly relevant in self-driving vehicles, where communication with a human driver is no longer possible and the vehicle may preferably communicate through light messaging or displays devices. Such devices may be preferably mounted on the inside of the vehicle for best protection from environmental conditions. Other opportunities for lighting functions include stop light, turn lights, etc., which may be mounted behind glass, such as Center High Mounted Stop Lights (CHMSL). According to aspects of the present disclosure, nano-structured anti-reflective coatings 10 may reduce the amount of light reflected by a glass surface, which may increase the amount of light transmitted through the glass surface as it is not being reflected. By increasing the light transmission of a glass surface with nano-structured anti-reflective coatings 10, the strength of a light source meant to transmit light through the glass surface may be reduced by the same amount, making the light source more efficient.

As discussed above, two improved nano-structured anti-reflective coatings 10 may be applied to the glass surfaces (surface S1 and surface S4) through which a communication is transmitted, whether through a partial or full glass window. Light intensity aspect ratios may be in principle similar to those above. However, the effect of the improved nano-structured anti-reflective coating 10 for reducing reflection may be more pronounced for light sources within a vehicle due to the typically lower light intensities in the vehicle versus outside the vehicle.

Anti-reflective surfaces may also be preferred for optical systems, such as cameras and sensors. The nano-structured, anti-reflective coating 10 of the present disclosure may be applied on a glass surface in front of a camera or sensor to provide improved observation through the glass surface. The anti-reflective surface may limit interference with the sensor or camera due to glare or reflection.

Glass having the nano-structured anti-reflective coatings 10 may provide a substrate that may not be visible to the human eye by significantly reducing reflection from both S1 and S4 surfaces. Glass substrates have varying levels of light transmission depending on the formulation of the glass and may be selected for their transmittance. For example, low levels of iron oxide may provide glass substrates that are clear in color with high light transmission values. The surface reflectivity, however, may reduce overall light transmission and create glare, which may be undesirable in certain applications, including museums, bank counters, selling offices, aquariums, mirrors, etc. Reducing the reflective properties of glass used in such applications may reduce the glare and increase light transmittance. The disclosed nano-structured anti-reflective coatings 10 on both S1 and S4 surfaces may further create new aesthetics for glass applications such as those discussed above and further, automotive glazing. The appearance of “invisible glass” having high durability is not currently available, where a reflectivity level of less than 1% may be required, preferably less than 0.5%, to establish a convincing “invisible” effect depending on specific applications. The nano-structured anti-reflective coating 10 disclosed may provide less than 1% reflectivity over wavelengths from 380 nm to 700 nm and provide a durable “invisible” glass when applied to both glass surfaces.

Additionally, it is common for automotive glazing to be tinted a green, blue or grey color to protect a driver or passengers in a vehicle from solar radiation (such as infra-red or UV radiation), to increase thermal comfort in the cabin, as well as adding a styling element to the vehicle. The disclosed coatings 10, 70, as shown in FIG. 6, may be used in colored glass constructions as well as clear glass constructions.

As shown in FIG. 5, the “invisible” glass may include a water repellent coating 16 and/or other materials with omni-phobic functions to create the illusion of a “force field.” Non-tinted glass with little or no reflection on its surfaces, which may provide a barrier to wind and rain, may resemble an “invisible force field.” In this non-limited embodiment, a chemical water-repellent coating 16 such as fluorine-based water repellent may be applied to the nano-scaled porous surface structure of the anti-reflective coating 10, providing water repellent properties to the windshield 2. Any suitable water repellent functional coating, including fluoroalkyl silane compounds, perfluoropolyether silane compounds, alkyl silane compounds, silazane compounds, and silicone compounds, disclosed in WO 2014021135, JP 2017218373 A, US 2016215169 and/or U.S. Pat. No. 5,268,198, may be used over a top coat of the windshield 2. Methods of applying such as coating may include dip coating, spin coating, spray coating, and nozzle flow coating followed by drying or firing processes. A durable super-hydrophobic coating 16 may provide a water droplet contact angle greater than 150 degrees. Particularly, the etched coating described herein may provide a water droplet contact angle of 156 degrees. The water droplet contact angle may be measured using an optical tensiometer and a 5 μl water droplet on a coated glass substrate 4, 8. The coated surface may remain superhydrophobic (contact angle ≥150 degrees) after abrasion treatment with aluminum oxide applied at a rate of 5 gram/minute for 2 minutes at 40 km/hr. Preferably, the contact angle may remain above 150 degrees after 8 minutes of such treatment. Particularly, the contact angle of the disclosed coating 10 under such conditions may remain at 155 degrees. Thus, the coating 10 disclosed may be durable and suitable for surface S1 applications to provide such an “invisible force field” during driving. The water droplet contact angle may be measured using an optical tensiometer and 5 μl water droplet on coated glass substrate. The nano-structured anti-reflective coating 10 and the hydrophobic coating 16 may stay intact through abrasion treatment. Thus. the coating 10 may be durable enough to survive exposure to physical and chemical elements, including those associated with a moving vehicle.

Referring to FIG. 6, in accordance with aspects of the present disclosure, a glass substrate 14 may be provided having a nano-structured anti-reflective coating 10 on an exterior S1 surface and a printed coating 70 on an interior surface S2. The printed coating 70 may be a solid print or provide a pattern. Any suitable printing medium, including enamel paints, may be used to form the printed coating 70. A printed glass substrate having a nano-structured anti-reflective coating 10 may be useful for various uses in architectural and automotive applications. For example, vehicle trim 3 may be generally used for functional and aesthetic reasons. The present disclosure may provide a design for vehicle interior and exterior trim pieces 3, panels, appliques, covers, etc. Specifically, the printed pieces 3 may include B and C pillar trim covers, beltline trim covers, or dashboard accent trim covers.

Typically, such trim pieces 3 may be made of painted parts, polished plastic or metal. Described herein is a glass substrate 14 for such applications, preferably very thin glass for low-weight applications. With paints, including enamel-based paint, the glass substrate 14 is printed on one surface. An anti-reflective nano-structured coating 10 on the opposite surface of the glass substrate 14 may reduce the reflectivity of the glass surface, thereby creating a full and deep aesthetic of the color printed on the glass substrate 14, as there may be no reflection to alter the appearance of the trim piece 3. Only the printed color 70 on the back of the glass substrate 14 may be visible. Further, it may resemble an appearance of depth as the eye has no reflection to determine the actual depth of the trim piece 3.

In an exemplary embodiment, a glass composite of 66% SiO₂, 26% B₂O₃, and 8% Na₂O may be magnetron sputter coated onto a flat glass substrate 4 that may be soda-lime-silica glass, in a layer 350 nm thick. A SiO₂layer may be on the flat glass substrate 4 prior to sputter coating the glass composite. The coated, flat glass substrate 4 may then be heated to 620 deg. C. The heating process may include gradually increasing and gradually decreasing temperature. The glass substrate 4 and coating may be heated at least 400 deg. C. for 14.8 minutes, at least 500 deg. C. for 10.85 minutes, and at least 600 deg. C. for 6.7 minutes. The glass substrate 4 may reach a maximum temperature of 659.5 deg. C. The process may take place in a Cattin furnace and include bending the glass substrate 4 and coating. During the heating process, the coating phase may separate into silica-rich phases and sodium-borate-rich phases. Once the bent glass substrate 4 cools, the coating may be etched to remove the sodium-borate-rich phase from the coating.

Etching may be completed, for example, by applying a 10:1 buffered oxide etch, including hydrogen fluoride and ammonium fluoride with deionized water, and removing the etchant after wet application for 20 seconds. A 20:1 buffered oxide etch may then be applied to the coating and removed after 20 seconds. Finally, a 30:1 buffered oxide etch may be applied to the coating and removed after 20 seconds. The etched coating 10 may have a nano-structured surface, including pores sized under 400 nm. The soda-lime-silica glass surface with the nano-structured coating 10 may have a reflectivity of 0.4%. The reflectivity may remain under 1.4% measured at angles of −40 degrees and 40 degrees.

Once the coating 10 is etched, a water repellent coating 16, 1H, 1H, 2H, 2H-perfluorooctyltrichlorosilane hexane solution, may be applied to the nano-structured coating 10. A water droplet contact angle, measured using an optical tensiometer and a 5 μl water droplet on a coated glass substrate 4, may be measured at 156 degrees. After aluminum oxide may be applied at 40 km/hr at 5 gram/minute for 8 minutes, the contact angle may be 155 degrees.

To prepare the inner glass substrate 8 in a laminated glass product 2, the glass composite may be applied to the S4 surface of the inner glass substrate 8 and treated as described herein for the outer glass substrate 4. The glass substrates 4, 8, having etched coatings 10, may then be laminated together with a PVB interlayer 6 having the nano-structured coatings 10 on outer surfaces S1 and S4.

In the case of a transparent tempered glass product, the glass composite may be sputter coated onto both sides glass substrate which may then be heated to heat treat the glass and to cause phase separation in the composite coating and cooled rapidly to cause tempering. The phase separated coatings on either side of the tempered glass may then be etched as described herein. In the case of a painted surface 70, only one side of the glass 14 may be coated with the glass composite on S1 and the opposite side S2 may be painted prior to the tempering process described herein. A SiO₂ layer may further be sputter coated onto the glass substrate prior to the glass composite deposition.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An automotive or architectural glass product, comprising:
a first side and a second side, wherein the first side faces an exterior side of the automotive or architectural glass product and the second side faces an interior side of the automotive or architectural glass product;
a first anti-reflective coating on the first side of the glass product; and
at least one of a second anti-reflective coating or a paint on the second side of the glass product, wherein:
the first anti-reflective coating is a first nano-structured coating having nano-structures less than or equal to 400 nm,
the first anti-reflective coating has nano-pores increasing in size through the first anti-reflective coating from the glass product to a first coating surface opposite the glass product,
the glass product has a reflectivity of 1% or less over wavelengths from 380 nm to 700 nm, and
the first anti-reflective coating comprises silica-based structures and sodium-borate portions.

2-3. (canceled)

4. The glass product according to claim 1, wherein the second anti-reflective coating comprises a second nano-structured coating having nano-structures less than or equal to 400 nm, and the second anti-reflective coating has nano-pores increasing in size through the second anti-reflective coating from the glass product to a second coating surface opposite the glass product.

5. The glass product according to claim 1, further comprising a paint on the second side of the glass product such that the paint covers at least 90% of the second side of the glass product, and wherein the paint comprises an enamel paint.

6. (canceled)

7. The glass product according to claim 1, further comprising a functional coating, that is at least one of water repellent and omni phobic, on the first anti-reflective coating.

8-9. (canceled)

10. The glass product according to claim 1,
wherein the glass product comprises a first glass substrate laminated with a second glass substrate, and
wherein the first glass substrate comprises the first side of the glass product and the second glass substrate comprises the second side of the glass product.

11-13. (canceled)

14. The glass product according to claim 1, wherein the glass product has reflectivity of 0.6% or less over wavelengths from 380 nm to 700 nm.

15. The glass product according to claim 1, wherein the glass product has reflectivity of 0.4% or less over wavelengths from 380 nm to 700 nm.

16. The glass product according to claim 1, wherein the first anti-reflective coating and the second anti-reflective coating provided on the first and second sides of the glass product, respectively, result in an intensity aspect ratio of greater than 117:1.

17. The glass product according to claim 1, wherein reflection from the first side of the glass product with the first anti-reflective coating at an angle from −40° to 40° is within 1% of reflection at 0°, wherein the first anti-reflective coating is substantially a single layer.

18-21. (canceled)

22. The glass product according to claim 1, further comprising a passivation layer between the first anti-reflective coating and the glass product.

23-24. (canceled)

25. A method of making a glazing, comprising:
providing a first glass substrate having first and second surfaces;
providing a coating on at least one surface of the first glass substrate, wherein the coating is phase separable;
heating the first glass substrate and coating to heat treat the first glass substrate and the cause phase separation in the coating, wherein heat treating the first glass substrate comprises at least one of bending the first glass substrate or tempering the first glass substrate; and
etching the coating, wherein etching the coating comprises partially etching the coating with a first etchant, removing the first etchant, further etching the coating with a second etchant, and removing the second etchant, wherein the second etchant is weaker than the first etchant,
wherein the etched coating has nano-structures less than or equal to 400 nm and nano-pores increasing in size through the etched coating from the first glass substrate to a first coating surface opposite the first glass substrate, and
wherein the glazing has a reflectivity of 1% or less over wavelengths from 380 nm to 700 nm.

26. The method according to claim 25, wherein the coating is provided on the first and second surfaces of the first glass substrate.

27. (canceled)

28. The method according to claim 25, wherein heat treating the first glass substrate comprises tempering the first glass substrate, wherein phase separation of the coating occurs while the first glass substrate and coating are heated, and then the first glass substrate and coating are cooled at a rate to temper the first glass substrate.

29. The method according to claim 25, further comprising:
providing a second glass substrate having third and fourth surfaces; and
providing at least one polymer interlayer, wherein the first and second glass substrates are spaced apart from each other with the polymer interlayer therebetween.

30. The method according to claim 29, further comprising applying the coating to at least one of the third and fourth surfaces of the second glass substrate.

31. The method according to claim 30, further comprising applying the coating to the third and fourth surfaces of the second glass substrate.

32. The method according to claim 25, wherein the coating is applied by physical vapor deposition onto the first glass substrate, wherein the first glass substrate is flat.

33. (canceled)

34. The method according to claim 25, wherein
the coating has a composition containing SiO₂, B₂O₃ and Na₂O,
the phase separation is spinodal decomposition that separates the coating into alkali-borate-rich and silica-rich phases, and
etching the coating comprises partially etching the alkali-borate-rich phase.

35-38. (canceled)
